(19) United States
(12) Patent Application Publication
(10) Pub. No.: US 2011/0149253 A1
(43) Pub. Date: Jun. 23, 2011

(54) Projection Image Display Apparatus with Multiple Light Sources

(75) Inventor: Sadahiko MIHASHI, Osaka (JP)

(73) Assignee: SANYO ELECTRIC CO., LTD., Osaka (JP)

(21) Appl. No.: 12/973,588

(22) Filed: Dec. 20, 2010

(30) Foreign Application Priority Data
Dec. 21, 2009 (JP) 2009-288847 P

(51) Int. Cl. G03B 21/14

(52) U.S. Cl. 353/85

(57) ABSTRACT

When a lamp to be used as a light source is switched to a first lamp from a second lamp, a control unit switches the state of a drive mirror to a state of transmitting light generated by a first lamp to a liquid crystal panel and sets a relay circuit to an I side to thereby switch the destination of electric power from a power supply from the second lamp to the first lamp. The control unit further reads an accumulated lighting period of the first lamp from a first memory in a first lamp unit and reads an accumulated lighting period of the second lamp from a second memory in a second lamp unit and calculates a target value of electric power to be supplied to the first lamp in accordance with respective accumulated lighting periods of the lamps.

This nonprovisional application is based on Japanese Patent Application No. 2009-288847 filed on Dec. 21, 2009 with the Japan Patent Office, the entire contents of which are hereby incorporated by reference.

### BACKGROUND OF THE INVENTION

1. Field of the Invention

The present invention relates to a projection image display apparatus, and more specifically to a projection image display apparatus having a plurality of light sources.

2. Description of the Related Art

Regarding a projection image display apparatus having a plurality of light sources, techniques have been disclosed that aim to prolong the lifetime of each light source by alternately lighting a first light source and a second light source. Regarding a projection image display apparatus having a first light source and a second light source, an example of the techniques lights the first and second light sources each in such a manner that each light source is lit only for a unit lighting period that is defined within a predetermined period, namely in a so-called intermittent lighting manner. In this way, the technique makes it possible to prolong the lifetime of the light source relative to the lifetime of the light source that is continuously lit.

According to another example regarding a light source apparatus mounted on a projection image display apparatus, when at least one of a plurality of light sources is lit while the other light source(s) is (are) off and the lighting status of the former lit light source has become abnormal, the latter off light source is then lit and, after the fact that the latter light source has been lit is confirmed, the former light source being lit is turned off. The apparatus is thus configured to keep the brightness of a displayed image at the time when the light source to be lit is changed from one to another.

In such a projection image display apparatus as described above in which the light source to be lit is changed from one to another among a plurality of light sources, there are not a few situations where one of the plurality of light sources becomes unavailable due to a failure or the like before exhausting its lifetime. For example, in the case where one of two light sources becomes unavailable due to a failure, the light source to be lit is changed from the failing light source to the other light source so as to keep projecting an image. Then, after a user replaces the failing lamp with a new lamp, the light source to be lit is changed again between the two light sources.

However, the replacement of one of the two light sources with a new one results in a difference between the light source and the other light source in terms of the accumulated lighting period. In general, the light source has a feature that the light source with a longer accumulated lighting period has a lower luminance. Therefore, in such a case as described above where only one of the light sources is replaced with a new one, the one light source and the other light source have a luminance difference therebetween depending on a difference in accumulated lighting period. If under this condition the two light sources are alternately lit, the brightness of a projected image changes each time the light source to be lit is switched from one to another, resulting in a problem that a viewer of the projection image display apparatus is caused to feel discomfort.

### SUMMARY OF THE INVENTION

According to an aspect of the present invention, a projection image display apparatus includes a first light source, a second light source, a light modulation element modulating light from the first light source or the second light source, a light guide unit for guiding the light from the first light source or the second light source through a common optical path to the light modulation element, a projection unit projecting the light modulated by the light modulation element, and a control unit performing light control for the first light source or the second light source in accordance with respective accumulated lighting periods of the first light source and the second light source.

According to another aspect of the present invention, a projection image display apparatus includes a first light source, a second light source, a light modulation element modulating light from the first light source or the second light source, a light guide unit for guiding the light from the first light source or the second light source through a common optical path to the light modulation element, a projection unit projecting the light modulated by the light modulation element, and a control unit controlling transmittance of light transmitted through the light modulation element, in accordance with respective accumulated lighting periods of the first light source and the second light source.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a main portion of a projector according to a first embodiment of the present invention.

FIG. 2 is a schematic configuration diagram of a main portion of the projector according to the first embodiment.

FIG. 3 is a diagram illustrating a control configuration of a control unit according to the first embodiment of the present invention.

FIG. 4 is a diagram illustrating a reading operation of reading an accumulated lighting period of each lamp by the control unit.

FIG. 5 is a flowchart illustrating the reading operation of reading an accumulated lighting period of each lamp by the control unit.

FIG. 6 is a diagram illustrating a relation between a luminance decrease rate and an accumulated lighting period of a light source.

FIG. 7 is a flowchart illustrating light control for a lamp by the control unit.

FIG. 8 is a diagram illustrating a control configuration of a control unit in a projector according to a second embodiment of the present invention.

FIG. 9 is a flowchart illustrating transmittance control for liquid crystal panels by the control unit.

### DESCRIPTION OF THE PREFERRED EMBODIMENTS

Embodiments of the present invention will hereinafter be described in detail with reference to the drawings. In the drawings, the same or corresponding components are denoted by the same reference characters, and a description thereof will not be repeated.

### First Embodiment

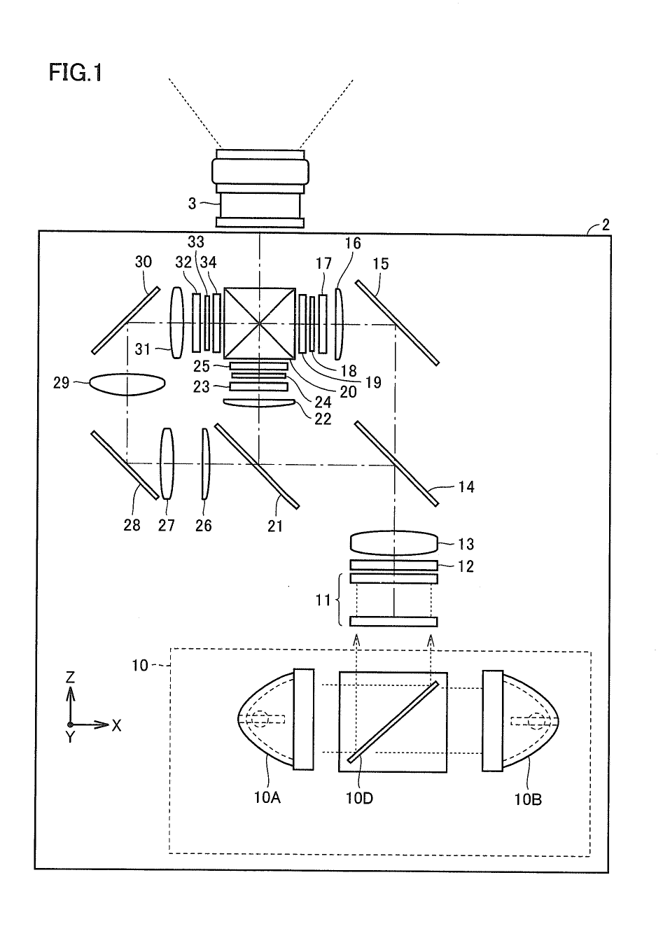

FIG. 1 is a diagram schematically showing a configuration of a main portion of a projection image display apparatus (hereinafter also referred to as “projector”) according to a first embodiment of the present invention.

Referring to FIG. 1, the projector is a liquid crystal projector using a liquid crystal device to project an image. The projector includes an optical engine 2 and a projection lens 3, and the outside of the projector is covered with a casing (not shown). While the projector also includes, for example, a component for audio output such as speaker, and a circuit board for electrically controlling the components of optical engine 2 and the audio output means, a part of the components including the aforementioned ones of the projector is not shown in FIG. 1.

Optical engine 2 includes an illumination device 10. Illumination device 10 includes two lamps (first lamp 10A, second lamp 10B) and a drive mirror 10D. Lamps 10A, 10B may be, for example, ultra-high pressure mercury lamp, metal halide lamp or xenon lamp. Lamps 10A and 10B are detachably attached to the casing. In other words, lamps 10A and 10B each of the projector can be replaced. Light from lamps 10A, 10B is emitted in the form of substantially parallel light rays by the action of a reflector.

Drive mirror 10D can be turned about the Y axis located at a central portion of drive mirror 10D in FIG. 1 by a drive mechanism which is not shown. Specifically, when first lamp 10A is actuated, drive mirror 10D is caused to assume the state for directing the light from first lamp 10A to a fly-eye integrator 11 as shown in FIG. 1. When second lamp 10B is actuated, drive mirror 10D is turned clockwise by 90° to assume the state for directing the light from second lamp 10B to fly-eye integrator 11.

The light emitted from illumination device 10 proceeds via fly-eye integrator 11 to enter a PBS (Polarization Beam Splitter) array 12 and a condenser lens 13. Fly-eye integrator 11 includes a fly-eye lens constituted of a group of lenses that appears to be an eye of a fly, and optically acts on the light from illumination device 10 so that the distribution of the quantity of light incident on liquid crystal panels 18, 24, 33 is uniform.

PBS array 12 is constituted of a plurality of PBSs and half-wave plates that are arranged in the form of an array, and causes the light rays from fly-eye integrator 11 to travel in one direction of polarization. Condenser lens 13 concentrates the light from PBS array 12. The light traveling through condenser lens 13 is then incident on a dichroic mirror 14.

Dichroic mirror 14 transmits only the light in the blue wavelength range (hereinafter “B light”) of the light from condenser lens 13, and reflects the light in the red wavelength range (hereinafter “R light”) and the light in the green wavelength range (hereinafter “G light”). The B light passing through dichroic mirror 14 is directed to and reflected by a mirror 15 and enters a condenser lens 16.

Condenser lens 16 optically acts on the B light so that the B light is incident on liquid crystal panel 18 in the form of substantially parallel light rays. The B light passing through condenser lens 16 is incident on liquid crystal panel 18 via an entry side polarization plate 17. Liquid crystal panel 18 is driven in accordance with an image signal for the blue color, and modulates the B light in accordance with the driven state. The B light modulated by liquid crystal panel 18 travels via an exit side polarization plate 19 to enter a dichroic prism 20.

Of the light reflected by dichroic mirror 14, the G light is reflected by a dichroic mirror 21 to enter a condenser lens 22. Condenser lens 22 optically acts on the G light so that the G light is incident on liquid crystal panel 24 in the form of substantially parallel light rays. The G light passing through condenser lens 22 is incident on liquid crystal panel 24 via an entry side polarization plate 23. Liquid crystal panel 24 is driven by an image signal for the green color and modulates the G light according to the driven state. The G light modulated by liquid crystal panel 24 travels via an exit side polarization plate 25 to enter dichroic prism 20.

The R light traveling through dichroic mirror 21 enters a condenser lens 26. Condenser lens 26 optically acts on the R light so that the R light is incident on liquid crystal panel 33 in the form of substantially parallel light rays. The R light passing through condenser lens 26 proceeds along an optical path including relay lenses 27, 29, 31 for adjusting the optical path length and two mirrors 28, 30, and is incident on liquid crystal panel 33 via an entry side polarization plate 32. Liquid crystal panel 33 is driven according to an image signal for the red color and modulates the R light according to the drive information. The R light modulated by liquid crystal panel 33 travels via an exit side polarization plate 34 to enter dichroic prism 20.

Dichroic prism 20 combines the B light, G light and R light modulated respectively by liquid crystal panels 18, 24 and 33 into colored composite light, and causes the light to enter projection lens 3. Projection lens 3 includes a group of lenses for projecting the light to form an image on a projection plane (screen), and an actuator for shifting a part of the lenses in the direction of the optical axis so as to adjust the state of zooming and the state of focusing an image to be projected. The colored composite light generated by dichroic prism 20 is enlarged and projected on the screen by projection lens 3.

As seen from the above, the projector according to the embodiment of the present invention has illumination device 10 including two lamps 10A, 10B, and the light emitted from first lamp 10A and the light emitted from second lamp 10B are directed through the common optical path to liquid crystal panels 18, 24, 33. The plurality of lamps can thus share the single optical path and accordingly the lamp to be used can be switched by effectively using the optical system without the need to provide respective optical paths for the lamps. In this way, the cost, the size, and the weight of the projector can be reduced.

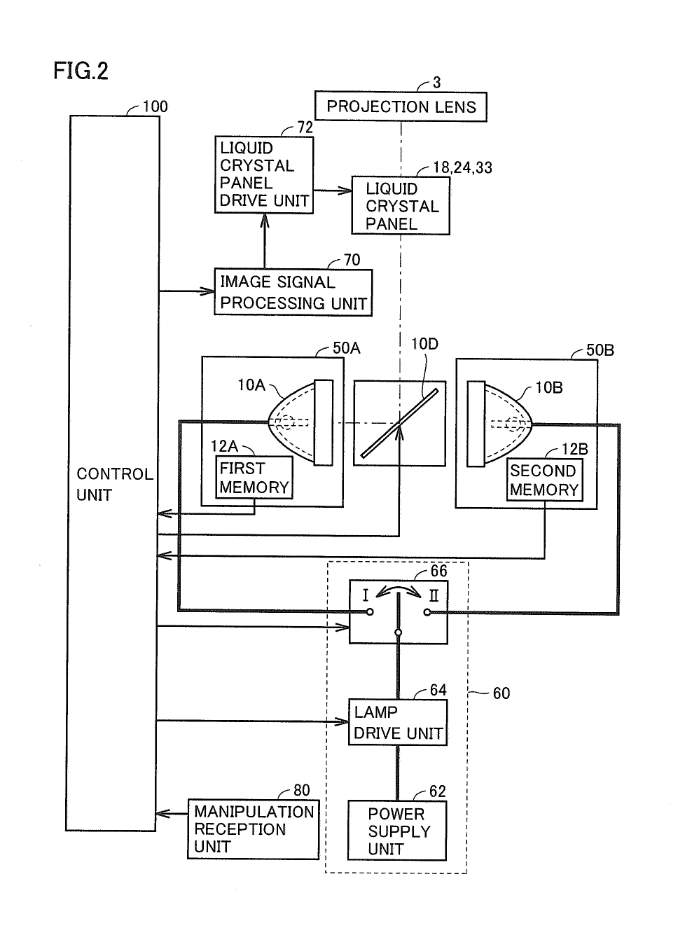

FIG. 2 is a schematic configuration diagram of a main portion of the projector according to the first embodiment.

Referring to FIG. 2, the projector includes a control unit 100 for entirely controlling operation of the projector. Control unit 100 is a CPU (Central Processing Unit), and communicates a signal with each component and controls operation of each component in accordance with a manipulation signal from a manipulation reception unit 80.

The projector also includes manipulation reception unit 80 that receives an externally performed manipulation. When a manipulation is performed on a manipulation unit (not shown) constituted of a plurality of manipulation buttons provided on the body of the projector or performed on a remote controller for remotely manipulating the projector, manipulation reception unit 80 receives the manipulation and transmits to control unit 100 a command signal serving as a trigger for various operations.

The projector further includes drive mirror 10D. Drive mirror 10D is driven by a drive mechanism (not shown) to switch between a state of guiding the light emitted from first lamp 10A to liquid crystal panels 18, 24, 33 (hereinafter also referred to as “first state”) and a state of guiding the light emitted from second lamp 10B to liquid crystal panels 18, 24, 33 (hereinafter also referred to as “second state”).

The projector further includes a lamp ballast unit 60 for supplying electric power to first lamp 10A or second lamp 10B. Lamp ballast unit 60 includes a power supply unit 62, a lamp drive unit 64, and a relay circuit 66.

Power supply unit 62 is supplied with electric power through a plug inserted in a socket of an AC power supply (not shown), and feeds the supplied electric power to each component in the projector.

Receiving the electric power from power supply unit 62, lamp drive unit 64 generates electric power for lighting first lamp 10A or second lamp 10B. The electric power generated by lamp drive unit 64 is controlled by control unit 100.

Specifically, when the destination of the electric power from power supply unit 62 is switched between first lamp 10A and second lamp 10B, control unit 100 follows a method as described below to calculate a target value of the electric power (hereinafter also referred to as “target electric power value”) P* to be supplied to the lamp to which the destination is switched. Then, control unit 100 generates a control command and provides the command to lamp drive unit 64 so that the electric power generated by lamp drive unit 64 has the calculated target electric power value P*. Following the control command from control unit 100, lamp drive unit 64 generates electric power and supplies the generated electric power to relay circuit 66. In other words, lamp drive unit 64 can change the output electric power in accordance with target electric power value P* which is set by control unit 100 to thereby change the brightness of illumination light emitted from illumination device 10.

Relay circuit 66 transmits the electric power supplied from lamp drive unit 64 to first lamp 10A or second lamp 10B. Specifically, following a switch command provided from control unit 100, relay circuit 66 is set to one of a I side and a II side.

More specifically, when the state of drive mirror 10D is to be switched from the second state to the first state, namely the lamp to be lit to serve as a light source is switched from second lamp 10B to first lamp 10A, relay circuit 66 is set to the I side. Accordingly, the electric power is supplied through relay circuit 66 to first lamp 10A.

In contrast, when the state of drive mirror 10D is to be switched from the first state to the second state, namely the lamp to be lit to serve as a light source is switched from first lamp 10A to second lamp 10B, relay circuit 66 is set to the II side. Accordingly, the electric power is supplied through relay circuit 66 to second lamp 10B.

Further, the projector includes an image signal processing unit 70 and a liquid crystal panel drive unit 72. Image signal processing unit 70 performs, on an image signal that is supplied through a receiver (not shown) from an external image source device, various kinds of image processing such as image quality adjustments including luminance adjustment, color balance adjustment, contrast adjustment, sharpness adjustment and the like, such as processing of enlarging/reducing the image size, and such as trapezoidal distortion correction and the like that is made when angled projection is performed by the projector.

Liquid crystal panel drive unit 72 generates, based on image data having been subjected to image processing by image signal processing unit 70, a drive signal for driving liquid crystal panels 18, 24, 33. In accordance with the drive signal generated by liquid crystal panel drive unit 72, liquid crystal panels 18, 24, 33 modulate the illumination light applied from illumination device 10.

Configuration of Lamp Unit

In the projector according to the present embodiment, first lamp 10A and second lamp 10B to be used as a light source are mounted in a first lamp unit 50A and a second lamp unit 50B, respectively. First lamp unit 50A and second lamp unit 50B are each detachably attached to the casing.

First lamp unit 50A includes first lamp 10A and a first memory 12A for storing information about first lamp 10A. First memory 12A is configured for example with a nonvolatile memory such as flash memory or hardware. The information about first lamp 10A includes information indicating that first lamp 10A is a genuine product, and information about an accumulated lighting period indicating an accumulated lighting period T1 of first lamp 10A.

The information indicating that the above-described lamp is a genuine product is constituted of an identifier (ID) specific to the lamp unit and made up of a combination of numbers, symbols or the like such as serial number, for example. When first lamp unit 50A is attached to the body of the apparatus, first memory 12A is connected so that it can communicate with control unit 100. Control unit 100 reads the ID stored in first memory 12A to determine whether or not first lamp unit 50A is a genuine product based on the ID.

Accumulated lighting period T1 of first lamp 10A when it is new is set to an initial value (T=0). When the lamp dies for example and is then replaced with new one, the lighting period, measured by a timer unit (not shown), is stored as an accumulated lighting period in first memory 12A. Accumulated lighting period T1 stored in first memory 12A is updated and recorded by control unit 100 each time first lamp 10A is turned on.

Second lamp unit 50B includes second lamp 10B and a second memory 12B for storing information about second lamp 10B. Second memory 12B has a similar configuration to first memory 12A, and stores, as the information about second lamp 10B, information (ID) indicating that second lamp 10B is a genuine product, and information about an accumulated lighting period indicating an accumulated lighting period T2 of second lamp 10B.

When second lamp unit 50B is attached to the body of the apparatus, second memory 12B is connected so that it can communicate with control unit 100. Control unit 100 reads the ID stored in second memory 12B to determine whether or not second lamp unit 50B is a genuine product based on the ID.

Accumulated lighting period T2 of second lamp 10B when it is new is set to an initial value (T=0). When the lamp dies for example and is then replaced with a new one, the lighting period, measured by a timer unit (not shown), is stored as an accumulated lighting period in second memory 12B. Accumulated lighting period T2 stored in second memory 12B is updated and recorded by control unit 100 each time second lamp 10B is turned on.

As seen from the above, in the projector according to the embodiment of the present invention, control unit 100 determines, based on an ID read from an internal memory of a lamp unit, whether a lamp to be used as a light source is a genuine product or not. When control unit 100 determines that the lamp to be used as a light source is not a genuine product, control unit 100 generates a signal ERR indicative of the result of the determination and outputs the signal to image signal processing unit 70. Image signal processing unit 70 uses an OSD (On Screen Display) capability to generate a message image indicating that the lamp is not a genuine product and outputs the image to liquid crystal panel drive unit 72. Accordingly, the message image is displayed by the OSD.

In contrast, when control unit 100 determines that the lamp to be used as a light source is a genuine product, control unit 100 measures the lighting period by means of the timer unit each time the lamp is turned on, and updates the accumulated lighting period stored in the corresponding memory.

Further, when the lamp to be used as a light source is switched between first lamp 10A and second lamp 10B, control unit 100 reads respective accumulated lighting period T1 and accumulated lighting period T2 stored respectively in first memory 12A and second memory 12B, and performs light control for the lamp to be lit as a light source in accordance with the read accumulated lighting period T1 and accumulated lighting period T2.

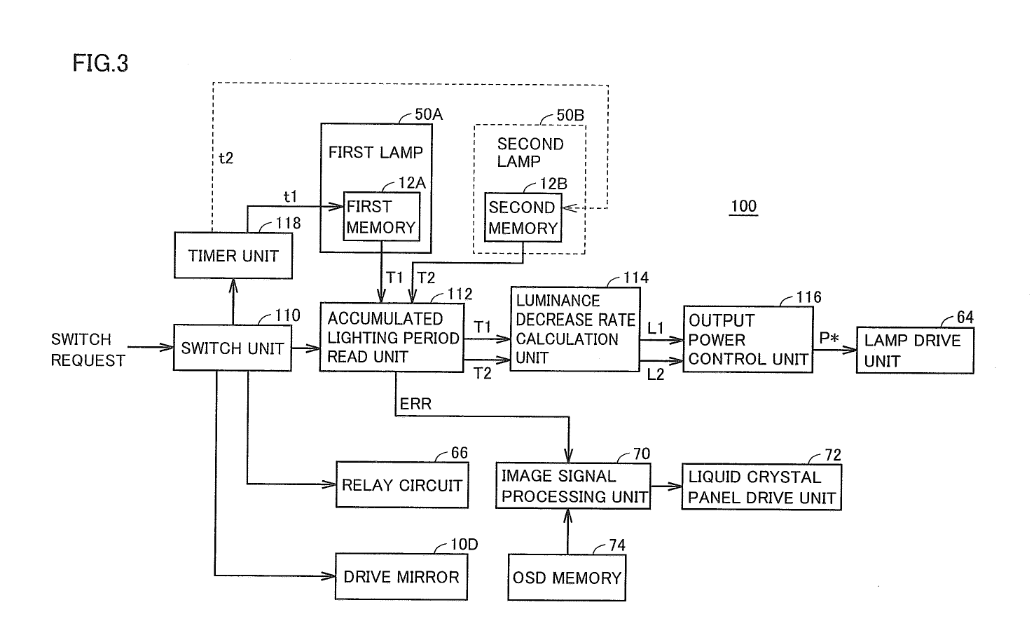

With reference to FIGS. 3 to 7, a description will now be given of details of operation performed by control unit 100 when the lamp to be used as a light source is switched between first lamp 10A and second lamp 10B.

Control Configuration

FIG. 3 is a diagram illustrating a control configuration of control unit 100 according to the first embodiment of the present invention.

Referring to FIG. 3, control unit 100 includes a switch unit 110, an accumulated lighting period read unit 112, a luminance decrease rate calculation unit 114, an output power control unit 116, and a timer unit 118.

In response to input of a command signal for switching the lamp to be used as a light source (hereinafter also referred to as “switch request”) from manipulation reception unit 80, switch unit 110 outputs to drive mirror 10D a signal for instructing to change the state of drive mirror 10D. Based on this signal, a drive mechanism (not shown) causes drive mirror 10D to turn so that drive mirror 10D is switched between the first state and the second state.

Switch unit 110 further outputs a switch command to relay circuit 66. Following this switch command, relay circuit 66 is set to one of the I side and the II side. Specifically, when the state of drive mirror 10D is switched from the second state to the first state, relay circuit 66 is set to the I side. When drive mirror 10D is switched from the first state to the second state, relay circuit 66 is set to the II side.

Following an instruction from switch unit 110, timer unit 118 measures the lighting period each time the lamp to be used as a light source is lit. Timer unit 118 writes the measured lighting period to a memory associated with the lamp to update the accumulated lighting period stored in this memory.

For example, when it is detected from a signal from switch unit 110 that the lamp to be used as a light source is switched from second lamp 10B to first lamp 10A, timer unit 118 measures lighting period t1 of first lamp 10A and updates accumulated lighting period T1 stored in first memory 12A.

In contrast, when it is detected from a signal from switch unit 110 that the lamp to be used as a light source is switched from first lamp 10A to second lamp 10B, timer unit 118 measures lighting period t2 of second lamp 10B and updates accumulated lighting period T2 stored in second memory 12B.

Accumulated lighting period read unit 112 receives from switch unit 110 a signal for instructing the lamp to be switched, and then communicates information about the lamp with first memory 12A and with second memory 12B. This communication is thus made to allow accumulated lighting period read unit 112 to read accumulated lighting period T1 of first lamp 10A from first memory 12A, and read accumulated lighting period T2 of second lamp 10B from second memory 12B.

Reading of Accumulated Lighting Period

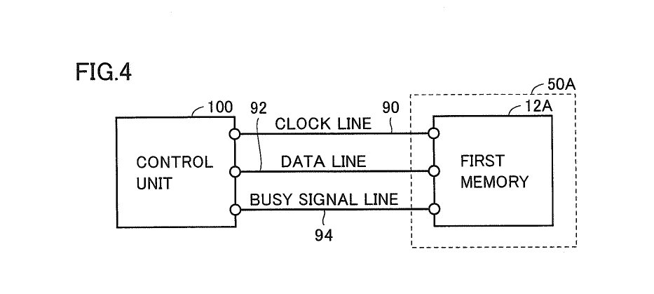

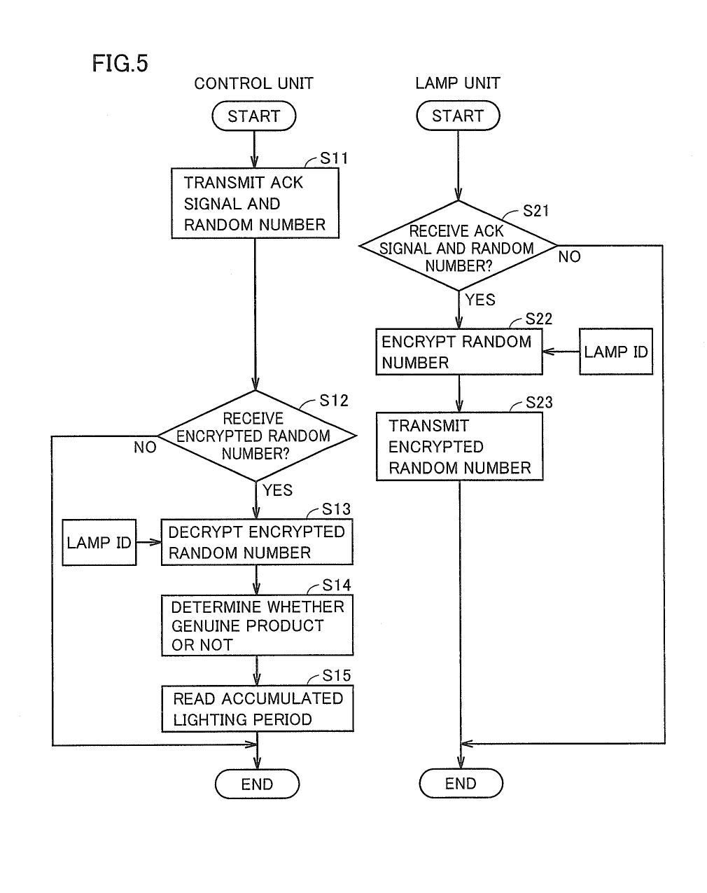

FIG. 4 is a diagram illustrating a reading operation of reading the accumulated lighting period of each lamp by control unit 100. While FIGS. 4 and 5 will be used to exemplarily explain the reading operation of reading the accumulated lighting period of first lamp 10A, the reading operation of reading the accumulated lighting period of second lamp 10B is performed by following a similar procedure.

Referring to FIG. 4, under the condition that first lamp unit 50A is attached to the body of the apparatus, control unit 100 and first memory 12A in first lamp unit 50A are connected by three communication lines 90, 92, 94 and one power supply line (not shown).

Specifically, communication line 90 serves to configure a clock line for communicating a clock signal to synchronize control unit 100 and first memory 12A with each other. Communication line 92 serves to configure a data line for communicating a data signal provided for light control for first lamp 10A, between control unit 100 and first memory 12A. This data signal also includes an ACK (acknowledge) signal that is a signal for confirming whether or not the communication environment is normal. At the start of the light control, control unit 100 transmits the ACK signal to first memory 12A and, based on whether or not a response signal to the ACK signal is given from first memory 12A, control unit 100 confirms whether or not the communication environment is normal.

Communication line 94 serves to configure a busy signal line for transmitting a busy signal generated from first memory 12A to control unit 100. The busy signal refers to a signal that is generated when first memory 12A is unable to respond to a signal transmitted from control unit 100. For example, when the light control started previously is now being executed for first memory 12A, the busy signal is transmitted through communication line 94 to control unit 100.

FIG. 5 is a flowchart illustrating the reading operation of reading the accumulated lighting period of each lamp by control unit 100. The flowchart of FIG. 5 is called from a main routine and executed each time the switch request is input from manipulation reception unit 80.

Referring to FIG. 5, control unit 100 first generates a random number together with the ACK signal and transmits these signals to first memory 12A of first lamp unit 50A (step S11). Control unit 100 then enters a state of receiving a response to the transmitted signals.

First lamp unit 50A is initially in a reception standby state for signals transmitted from control unit 100. At this time, first memory 12A uses a timer to measure the standby time and, when the measured time exceeds a preset standby time (NO in step S21), first memory 12A ends the operation.

In step S21, when the signals transmitted from control unit 100 are received within the set time (YES in step S21), first memory 12A determines that the communication environment is normal. Then, first memory 12A encrypts the received random number using, as a key, the ID of first lamp unit 50A (hereinafter also referred to as lamp ID) stored in advance (step S22). The random number encrypted with the lamp ID as a key is transmitted to control unit 100 (step S23).

Control unit 100 in a reception standby state measures the standby time by means of a timer, similarly to first memory 12A. When the measured time exceeds a set time (NO in step S12), control unit 100 ends the reading operation.

In contrast, when a response from first memory 12A is received within the set time, control unit 100 reads the lamp ID stored in advance in the memory, and decrypts the random number using the lamp ID as a key (step S13).

At this time, when the decrypted random number and the original random number transmitted to first memory 12A are identical, namely the decryption by means of the lamp ID as a key has been successful, control unit 100 determines that first lamp unit 50A is a genuine product. In contrast, when the decrypted random number and the original random number transmitted to first memory 12A are not identical, namely the decryption by means of the lamp ID as a key has been unsuccessful, control unit 100 determines that first lamp unit 50A is not a genuine product (step S14).

When it is determined in step S14 that first lamp unit 50A is not a genuine product, control unit 100 transmits signal ERR to image signal processing unit 70 to thereby cause image signal processing unit 70 to generate a message image indicating that first lamp unit 50A is not a genuine product. Thus, the message image is displayed by OSD.

In contrast, when it is determined in step S14 that first lamp unit 50A is a genuine product, control unit 100 reads accumulated lighting period T1 of first lamp 10A stored in first memory 12A (step S15).

Calculation of Luminance Decrease Rate

Referring again to FIG. 3, accumulated lighting period read unit 112 performs the processing shown in FIG. 5 to read accumulated lighting period T1 of first lamp 10A from first memory 12A and read accumulated lighting period T2 of second lamp 10B from second memory 12B, and accordingly outputs these accumulated lighting period T1 and accumulated lighting period T2 to luminance decrease rate calculation unit 114.

Luminance decrease rate calculation unit 114 calculates a luminance decrease rate L1 of first lamp 10A based on accumulated lighting period T1 of first lamp 10A. Luminance decrease rate calculation unit 114 also calculates a luminance decrease rate L2 of second lamp 10B based on accumulated lighting period T2 of second lamp 10B.

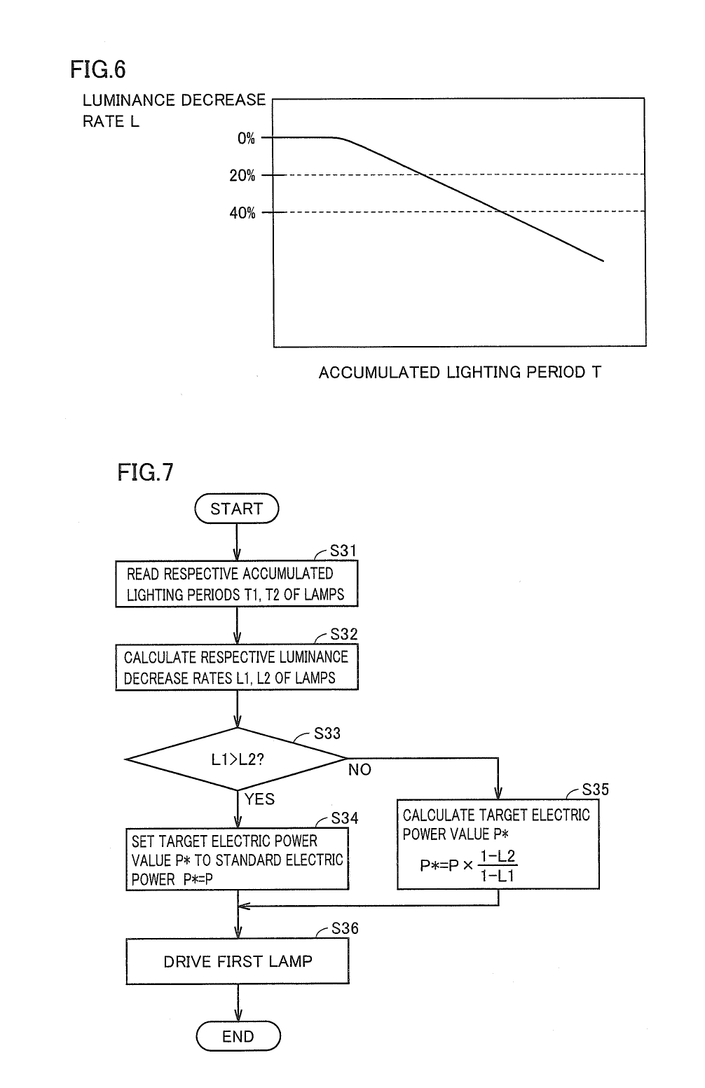

Here, the luminance decrease rate represents the rate of decrease in luminance of a lamp as compared with that when the lamp is new. As shown in FIG. 6, the luminance decrease rate has a relation with the accumulated lighting period, namely the luminance decrease rate increases as the accumulated lighting period increases. Luminance decrease rate calculation unit 114 refers to the relation between the luminance decrease rate and the accumulated lighting period shown in FIG. 6 to calculate the luminance decrease rate corresponding to the accumulated lighting period for each lamp.

Regarding the calculation of the luminance decrease rate, control unit 100 may hold in advance the relation shown in FIG. 6 as a map for calculating the luminance decrease rate and, each time the lamp to be used as a light source is switched, the map may be referenced to calculate the luminance decrease rate corresponding to the accumulated lighting period. Alternatively, a predetermined calculation expression representing the relation shown in FIG. 6 may be used to calculate the luminance decrease rate from the accumulated lighting period.

In accordance with luminance decrease rate L1 of first lamp 10A and luminance decrease rate L2 of second lamp 10B that are calculated by luminance decrease rate calculation unit 114, output power control unit 116 controls the electric power supplied from power supply unit 62 to a lamp to which the lamp to be used as a light source is switched, to thereby perform the light control of adjusting the brightness of light emitted from the lamp.

Specifically, in accordance with respective luminance decrease rates L1 and L2 of the lamps, output power control unit 116 sets a target value of electric power (target electric power value) P* to be supplied from power supply unit 62 to a lamp to which the lamp to be used as a light source is switched. Then, output power control unit 116 generates a control command and provides it to lamp drive unit 64 so that the electric power generated by lamp drive unit 64 is equal to target electric power value P* having been set.

Lamp drive unit 64 supplies to relay circuit 66 the electric power generated in accordance with the control command from output power control unit 116. Specifically, following target electric power value P* that is set by output power control unit 116, lamp drive unit 64 changes the output electric power to thereby change the brightness of the illumination light emitted from illumination device 10.

Light Control for Lamp

The light control for a lamp by control unit 100 will be described in detail.

FIG. 7 is a flowchart illustrating the light control for a lamp by control unit 100. FIG. 7 will be used to explain details of processing performed by control unit 100 when the lamp to be used as a light source is switched from second lamp 10B to first lamp 10A.

Referring to FIG. 7, when a switch request is input from manipulation reception unit 80 for changing the lamp to be used as a light source from second lamp 10B to first lamp 10A, accumulated lighting period read unit 112 follows the above-described method to read accumulated lighting period T1 of first lamp 10A from first memory 12A of first lamp unit 50A and also read accumulated lighting period T2 of second lamp 10B from second memory 12B of second lamp unit 50B (step S31).

In step S32, luminance decrease rate calculation unit 114 refers to the luminance decrease rate calculation map (FIG. 6) to calculate respective luminance decrease rates L1, L2 corresponding to accumulated lighting period T1 and accumulated lighting period T2 of respective lamps.

In steps S33 to S35, output power control unit 116 sets a target value of electric power (target electric power value) P* supplied to first lamp 10A to which the lamp to be used as a light source is switched, in accordance with respective luminance decrease rates L1, L2 of the lamps.

Specifically, output power control unit 116 first determines whether or not luminance decrease rate L1 of first lamp 10A is higher than luminance decrease rate L2 of second lamp 10B (step S33). When luminance decrease rate L1 of first lamp 10A is higher than luminance decrease rate L2 of second lamp 10B (YES in step S33), output power control unit 116 follows an expression (1) below to set target electric power value P* to a standard output electric power of power supply unit 62 (hereinafter also referred to as “standard electric power”) P in a normal operating state (step S34).

P*=P (1)

In contrast, when luminance decrease rate L1 of first lamp 10A is not more than luminance decrease rate L2 of second lamp 10B (NO in step S33), output power control unit 116 follows an expression (2) below to calculate target electric power value P* based on respective luminance decrease rates L1, L2 of the lamps (step S35)

P*=P×(1−L2)/(1−L1) (2)

In expression (2) above, (1−L2)/(1−L1) represents the current ratio of luminance between first lamp 10A and second lamp 10B. Therefore, as seen from expression (2), when luminance decrease rate L1 of first lamp 10A is not more than luminance decrease rate L2 of second lamp 10B, namely the current luminance of first lamp 10A is not less than the current luminance of second lamp 10B, the electric power supplied to first lamp 10A is controlled in such a manner that the electric power is reduced in accordance with the ratio in luminance between the lamps. In this way, in accordance with the brightness of the light having been emitted from second lamp 10B, the brightness of the light emitted from first lamp 10A after switching of the lamp is limited.

As seen from the above, when the lamp to be used as a light source is switched from second lamp 10B to first lamp 10A, the electric power supplied to first lamp 10A is controlled in accordance with respective luminance decrease rates corresponding to respective accumulated lighting periods of the lamps, and accordingly change of the brightness of the light emitted from illumination device 10 after the lamp is switched to first lamp 10A can be suppressed. In this way, it can be avoided to make a viewer of the projector feel discomfort.

When the lamp to be used as a light source is switched from first lamp 10A to second lamp 10B, it is determined in step S33 of FIG. 7 whether or not luminance decrease rate L2 of second lamp 10B is higher than luminance decrease rate L1 of first lamp 10A. When luminance decrease rate L2 of second lamp 10B is higher than luminance decrease rate L1 of first lamp 10A, target electric power value P* is set to standard electric power P in step S34. In contrast, when luminance decrease rate L2 of second lamp 10B is not more than luminance decrease rate L1 of first lamp 10A, target electric power value P* is calculated in accordance with respective luminance decrease rates L1, L2 of the lamps in step S35.

Here, it is assumed for example that luminance decrease rate L1 of first lamp 10A corresponding to accumulated lighting period T1 is 10%, while luminance decrease rate L2 of second lamp 10B corresponding to accumulated lighting period T2 is 50%, which are calculated with reference to the luminance decrease rate calculation map in FIG. 6.

Under this condition, when the lamp to be used as a light source is switched from second lamp 10B to first lamp 10A, a relation of L1<L2 is satisfied in step S33 of FIG. 7 and accordingly target electric power value P* is calculated following an expression (3) below in step S35 of FIG. 7.

P*=P×(1−0.5)/(1−0.1) (3)

Then, following this calculated target electric power value P*, lamp drive unit 64 supplies electric power through relay circuit 66 to first lamp 10A, and thus luminance LA of first lamp 10A can be approximated as done by an expression (4) below.

$$\begin{matrix}LA = α \times {P}^{*} \times ( 1 - L 1 ) \\ = α \times P \times 0.5\end{matrix} \qquad ( 4 )$$

Here, α is a coefficient representing a relation between supplied electric power and the luminance of a lamp that is set in accordance with characteristics of the lamp.

In contrast, when the lamp to be used as a light source is switched from first lamp 10A to second lamp 10B under the above-described condition, a relation of L2>L1 is satisfied and accordingly target electric power value P* is set to standard electric power P in step S33 of FIG. 7. Then, following the set target electric power value P*, lamp drive unit 64 supplies electric power through relay circuit 66 to second lamp 10B, and thus luminance LB of second lamp 10B can be approximated as done by expression (5) below.

$$\begin{matrix}LB = α \times {P}^{*} \times ( 1 - L 2 ) \\ = α \times P \times 0.5\end{matrix} \qquad ( 5 )$$

Here, it is seen from a comparison between expression (4) and expression (5) that the luminance when the lamp to be used as a light source is switched to first lamp 10A and the luminance when the lamp to be used as a light source is switched to second lamp 10B are substantially identical to each other.

In the first embodiment of the present invention, first lamp 10A and second lamp 10B correspond to “first light source and second light source”, liquid crystal panels 18, 24, 33 correspond to “light modulation element”, a group of mirrors and a group of lenses including fly-eye integrator 11, PBS array 12 and condenser lens 13 correspond to “light guide unit”, lamp ballast unit 60 corresponds to “power supply unit”, and drive mirror 10D corresponds to “switch unit”. Further, control unit 100 implements “power supply control unit”, “light control unit”, and “read unit”.

As heretofore described, in the projector according to the first embodiment of the present invention that is configured to switch the destination of electric power supplied from a single power supply unit between first lamp 10A and second lamp 10B, the electric power supplied to the lamp is controlled (light control) in accordance with respective accumulated lighting periods of the lamps. Accordingly, even when the lamp to be used is switched between a plurality of lamps having respective accumulated lighting periods different from each other, change of the brightness of a projected image can be suppressed. Consequently, the lamp to be used can be switched without making a viewer of the projector feel discomfort.

Further, even when the electric power is supplied from a single power supply unit to a plurality of lamps, namely power supply units are not provided for respective lamps, the lamp to be used can be switched without making a viewer feel discomfort and therefore reduction in cost, size, and weight of the projector can be achieved.

### Second Embodiment

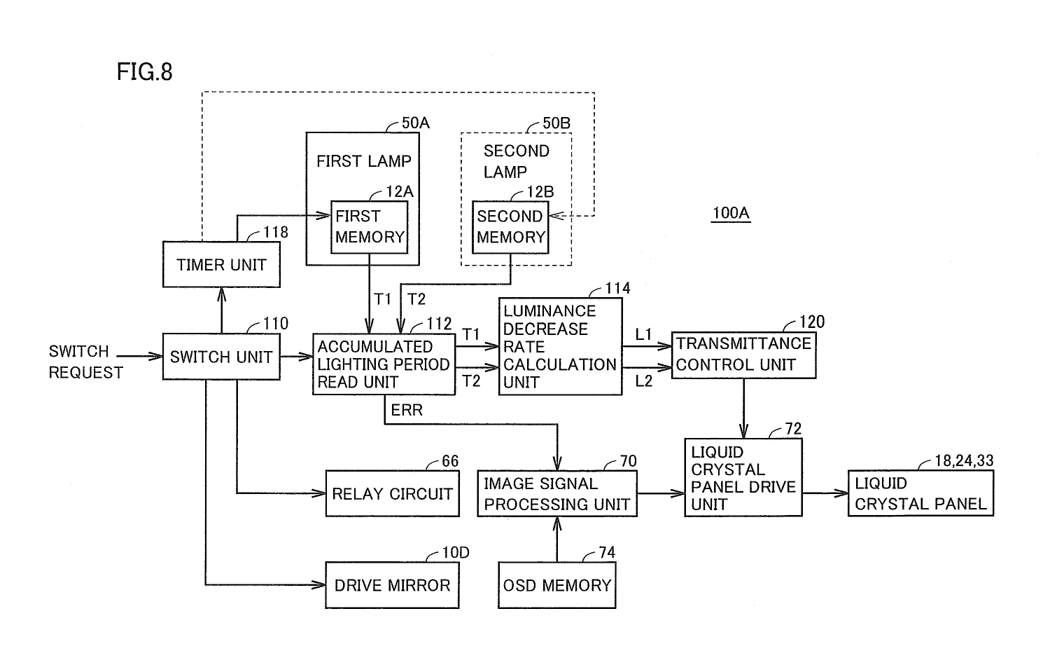

FIG. 8 is a diagram illustrating a control configuration of a control unit 100A in a projector according to a second embodiment of the present invention. Referring to FIG. 8, control unit 100A in the second embodiment of the present invention differs from control unit 100 in the first embodiment of the present invention shown in FIG. 3 in that the former includes a transmittance control unit 120 instead of output power control unit 116. Therefore, the detailed description of the features common to control unit 100A and control unit 100 in FIG. 3 will not be repeated.

Transmittance control unit 120 receives respective luminance decrease rates L1, L2 of the lamps from luminance decrease rate calculation unit 114 to control the transmittance of the light to be transmitted through liquid crystal panels 18, 24, 33 in accordance with luminance decrease rates L1, L2 and thereby adjust the brightness of a projected image.

Specifically, in accordance with respective luminance decrease rates L1 and L2 of the lamps, transmittance control unit 120 sets a target value of the transmittance (hereinafter also referred to as target transmittance value) T* of liquid crystal panels 18, 24, 33. Then, transmittance control unit 120 provides to liquid crystal panel drive unit 72 a control command indicating the set target transmittance value T*.

Based on image data from image signal processing unit 70, liquid crystal panel drive unit 72 generates a drive signal for driving liquid crystal panels 18, 24, 33. At this time, liquid crystal panel drive unit 72 adjusts the voltage applied to liquid crystal panels 18, 24, 33 that is necessary for setting the transmittance of liquid crystal panels 18, 24, 33 to target transmittance value T*. Following the drive signal generated by liquid crystal panel drive unit 72, liquid crystal panels 18, 24, 33 modulate illumination light emitted from illumination device 10. Accordingly, the light emitted from illumination device 10 is transmitted through liquid crystal panels 18, 24, 33 with the transmittance determined in accordance with target transmittance value T*, and an image displayed on liquid crystal panels 18, 24, 33 is projected on a screen in an enlarged form.

Transmittance Control for Liquid Crystal Panels

Transmittance control for liquid crystal panels 18, 24, 33 by control unit 100A will now be described in detail.

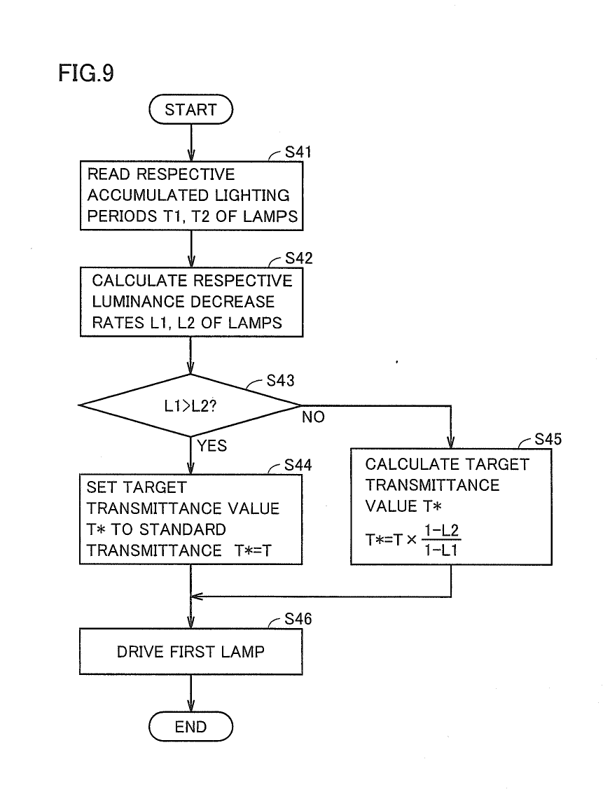

FIG. 9 is a flowchart illustrating transmittance control for liquid crystal panels by control unit 100A. FIG. 9 will be used to explain details of processing executed by control unit 100A when the lamp to be used as a light source is switched from second lamp 10B to first lamp 10A.

Referring to FIG. 9, when a switch request is input from manipulation reception unit 80 for switching the lamp to be used as a light source from second lamp 10B to first lamp 10A, accumulated lighting period read unit 112 follows the above-described method to read accumulated lighting period T1 of first lamp 10A from first memory 12A of first lamp unit 50A, and also read accumulated lighting period T2 of second lamp 10B from second memory 12B of second lamp unit 50B (step S41).

In step S42, luminance decrease rate calculation unit 114 refers to the luminance decrease rate calculation map (FIG. 6) to calculate luminance decrease rates L1, L2 corresponding to respective accumulated lighting periods T1, T2 of the lamps.

In steps S43 to S45, transmittance control unit 120 sets, in accordance with respective luminance decrease rates L1, L2 of the lamps, a target value of the transmittance (target transmittance value) T* of liquid crystal panels 18, 24, 33 after the lamp to be used is switched to first lamp 10A.

Specifically, transmittance control unit 120 first determines whether or not luminance decrease rate L1 of first lamp 10A is higher than luminance decrease rate L2 of second lamp 10B (step S43). When luminance decrease rate L1 of first lamp 10A is higher than luminance decrease rate L2 of second lamp 10B (YES in step S43), transmittance control unit 120 follows an expression (6) below to set target transmittance value T* to a transmittance of liquid crystal panels 18, 24, 33 that is standard in normal operation (hereinafter also referred to as standard transmittance) T (step S44).

T*=T (6)

In contrast, when luminance decrease rate L1 of first lamp 10A is not more than luminance decrease rate L2 of second lamp 10B (NO in step S43), transmittance control unit 120 follows the calculation indicated by an expression (7) below to calculate target transmittance value P* based on respective luminance decrease rates L1, L2 of the lamps (step S45).

T*=T×(1−L2)/(1−L1) (7)

In expression (7) above, (1−L2)/(1−L1) represents the current ratio in luminance between first lamp 10A and second lamp 10B. Therefore, according to expression (7), when luminance decrease rate L1 of first lamp 10A is not more than luminance decrease rate L2 of second lamp 10B, namely the current luminance of first lamp 10A is not less than the current luminance of second lamp 10B, the transmittance of liquid crystal panels 18, 24, 33 is controlled so that the transmittance is reduced in accordance with the ratio in luminance between the lamps. In this way, in accordance with the brightness of light having been emitted from second lamp 10B, the brightness of light emitted from first lamp 10A after switching of the lamp is limited.

In step S46, in accordance with target transmittance value T* that is set in step S44 or S45, liquid crystal panel drive unit 72 adjusts the voltage applied to liquid crystal panels 18, 24, 33. Specifically, transmittance control unit 120 has already had a V-T characteristic indicating a relation between applied voltage V and transmittance T of liquid crystal panels 18, 24, 33, and refers to this V-T characteristic to adjust the applied voltage corresponding to target transmittance value T*.

As seen from the above, when the lamp to be used as a light source is switched from second lamp 10B to first lamp 10A, the transmittance of liquid crystal panels 18, 24, 33 is controlled in accordance with respective luminance decrease rates corresponding to respective accumulated lighting periods of the lamps, and accordingly change of the brightness of light can be suppressed that is emitted from illumination device 10 after the lamp to be used is switched to first lamp 10A. In this way, it can be avoided to make a viewer of the projector feel discomfort.

Here, when the lamp to be used as a light source is switched from first lamp 10A to second lamp 10B, it is determined in step S43 of FIG. 9 whether or not luminance decrease rate L2 of second lamp 10B is higher than luminance decrease rate L1 of first lamp 10A. When luminance decrease rate L2 of second lamp 10B is higher than luminance decrease rate L1 of first lamp 10A, target transmittance value T* is set in step S44 to standard transmittance value T. In contrast, when luminance decrease rate L2 of second lamp 10B is not more than luminance decrease rate L1 of first lamp 10A, target transmittance value T* is calculated in step S45 in accordance with respective luminance decrease rates L1, L2 of the lamps.

In the second embodiment of the present invention, control unit 100A implements “power supply control unit” and “transmittance control unit”.

As heretofore described, in the projector according to the second embodiment of the present invention that is configured to switch the destination of electric power from a single power supply unit between first lamp 10A and second lamp 10B, the transmittance of light transmitted through the liquid crystal panels is controlled in accordance with respective accumulated lighting periods of the lamps. Accordingly, even when the lamp to be used is switched between a plurality of lamps having respective accumulated lighting periods different from each other, change of the brightness of a projected image can be suppressed. Consequently, the lamp to be used can be switched without making a viewer of the projector feel discomfort.

While the above-described first and second embodiments are configured to switch the lamp to be used as a light source in response to the switch request provided through manipulation reception unit 80, the present invention is not limited to this. For example, control unit 100 or 100A may monitor respective lighting periods of the lamps that are measured by timer unit 118 and cause the lamp to be switched automatically when a predetermined lighting period has elapsed.

Further, while the first and second embodiments have been described in connection with the configuration in which illumination device 10 includes two lamps and the lamp to be used as a light source is alternately switched between the two lamps, the present invention is also applicable to a configuration in which illumination device 10 includes three or more lamps. In this case, the state of drive mirror 10D is changed so that respective light beams emitted from the lamps are guided through a common optical path to liquid crystal panels 18, 24, 33.

Further, while the above-described first and second embodiments use a liquid crystal projector as the projector, the present invention is not limited to this. For example, the technique of the present invention may be used for other types of projectors such as DLP (Digital Light Processing) (trademark)-type projector for example.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection image display apparatus comprising:
a first light source;
a second light source;
a light modulation element which modulates light from said first light source or said second light source;
a light guide unit which guides the light from said first light source or said second light source through a common optical path to said light modulation element;
a projection unit which projects the light modulated by said light modulation element; and
a control unit which performs light control for said first light source or said second light source in accordance with respective accumulated lighting periods of said first light source and said second light source.

2. The projection image display apparatus according to claim 1, further comprising a switch unit which makes a switch between a first state of guiding the light emitted from said first light source to said light guide unit and a second state of guiding the light emitted from said second light source to said light guide unit.

3. The projection image display apparatus according to claim 2, further comprising a power supply unit which supplies electric power to said first light source or said second light source, wherein
said control unit includes:
a power supply control unit which switches a destination of electric power from said power supply unit, from said first light source to said second light source, when said switch unit is changed from said first state to said second state, and switches the destination of electric power from said power supply unit, from said second light source to said first light source, when said switch unit is changed from said second state to said first state; and
a light control unit which controls, when the destination of electric power from said power supply unit is switched from said first light source to said second light source, electric power to be supplied to said second light source in accordance with respective luminance decrease rates corresponding to respective accumulated lighting periods of said first light source and said second light source, and controls, when the destination of electric power from said power supply unit is switched from said second light source to said first light source, electric power to be supplied to said first light source in accordance with respective luminance decrease rates corresponding to respective accumulated lighting periods of said first light source and said second light source.

4. The projection image display apparatus according to claim 1, wherein
said first light source includes a first storage unit which holds an accumulated lighting period of said first light source,
said second light source includes a second storage unit which holds an accumulated lighting period of said second light source, and
said control unit includes a read unit which reads the accumulated lighting period of said first light source from said first storage unit and the accumulated lighting period of said second light source from said second storage unit.

5. A projection image display apparatus comprising:
a first light source;
a second light source;
a light modulation element which modulates light from said first light source or said second light source;
a light guide unit which guides the light from said first light source or said second light source through a common optical path to said light modulation element;
a projection unit which projects the light modulated by said light modulation element; and
a control unit which controls transmittance of light transmitted through said light modulation element, in accordance with respective accumulated lighting periods of said first light source and said second light source.

6. The projection image display apparatus according to claim 5, further comprising:
a power supply unit which supplies electric power to said first light source or said second light source; and
a switch unit which makes a switch between a first state of guiding the light emitted from said first light source to said light guide unit and a second state of guiding the light emitted from said second light source to said light guide unit, wherein
said control unit includes:
a power supply control unit which switches a destination of electric power from said power supply unit, from said first light source to said second light source, when said switch unit is changed from said first state to said second state, and switches the destination of electric power from said power supply unit, from said second light source to said first light source, when said switch unit is changed from said second state to said first state; and
a transmittance control unit which controls said transmittance in accordance with respective luminance decrease rates corresponding to respective accumulated lighting periods of said first light source and said second light source, when the destination of electric power from said power supply unit is switched between said first light source and said second light source.
